(19) United States
(12) Patent Application Publication
(10) Pub. No.: US 2025/0208556 A1
(43) Pub. Date: Jun. 26, 2025

(54) IMAGE FORMING APPARATUS AND CONTROL METHOD THEREFOR, AND STORAGE MEDIUM

(71) Applicant: CANON KABUSHIKI KAISHA, Tokyo (JP)

(72) Inventors: GO SHINDO, Shizuoka (JP); MASATAKA MOCHIZUKI, Shizuoka (JP)

(21) Appl. No.: 18/987,556

(22) Filed: Dec. 19, 2024

(30) Foreign Application Priority Data
Dec. 20, 2023 (JP) 2023-215048

(51) Int. Cl. G03G 15/00; G03G 15/08

(52) U.S. Cl. CPC G03G 15/556; G03G 15/0862

(57) ABSTRACT

In an image forming apparatus, a processing unit generates an image signal by performing dithering as halftone processing on an input image. A control unit obtain a consumption amount of a developer for forming a developer image, on the basis of the image signal. The control unit obtains the consumption amount using (i) a count value obtained by individually counting OFF pixel groups included in an image corresponding to the image signal, each OFF pixel group being constituted by consecutive OFF pixels and having a different consecutive number of consecutive OFF pixels, and (ii) a size of a dither matrix used in the dithering.

### BACKGROUND OF THE INVENTION

### Field of the Invention

The present invention relates to an image forming apparatus that forms images using an electrophotographic method, a control method therefor, and a storage medium.

### Description of the Related Art

In an electrophotographic image forming apparatus that forms an image using a developer (toner), such as a printer, a copier, a facsimile device, or the like, there is a need to ascertain the amount of toner consumed (or remaining) to replenish the toner or replace a toner cartridge. For example, according to the technique disclosed in Japanese Patent Laid-Open No. 2002-174929, printed dot columns are classified into a plurality of patterns according to the state of continuity of the dots, and the number of times the patterns occur are counted individually. Furthermore, the total toner consumption amount is calculated by multiplying each of the count values by a predetermined coefficient. Through this, the toner consumption amount is determined with high accuracy, regardless of non-linearity between the number of dots and the amount of toner adhered, caused by differences in the state of continuity of the dots.

Additionally, according to the technique disclosed in Japanese Patent Laid-Open No. 2006-98953, the spacing between each dot and another dot adjacent thereto is used to improve the accuracy at which the toner consumption amount is calculated. With this technique, the amount of toner adhering to a region where toner is not expected to adhere, formed between the toner dots, is predicted on the basis of the spacing of the dots.

With the past techniques mentioned above, the fact that the amount of toner adhering to the region where the toner is not expected to adhere differs depending on the spacing of the dots is used to improve the accuracy at which the toner consumption amount is calculated. However, in a case where dithering is performed as halftone processing on an input image, the accuracy of predictions of the toner consumption amount, made using the spacing between the dots formed, may drop. This is because in a case where, for example, the area ratio of the post-dithering image is small, the decrease in the toner consumption amount caused by the formed dots being smaller is not reflected in the prediction of the toner consumption amount.

### SUMMARY OF THE INVENTION

Accordingly, the present disclosure provides a technique for preventing a drop in the accuracy of predicting the amount of a developer (toner) consumed in a case of performing dithering on an input image.

According to one aspect of the present disclosure, there is provided an image forming apparatus comprising: a photosensitive member; a processing unit configured to generate an image signal by performing dithering as halftone processing on an input image; an exposure unit configured to form an electrostatic latent image on the photosensitive member by exposing the photosensitive member on the basis of the image signal; a developing unit configured to form a developer image on the photosensitive member by developing the electrostatic latent image using a developer; and an obtainment unit configured to obtain a consumption amount of the developer for forming the developer image, on the basis of the image signal, wherein the obtainment unit is configured to obtain the consumption amount using (i) a count value obtained by individually counting OFF pixel groups included in an image corresponding to the image signal, each OFF pixel group being constituted by consecutive OFF pixels and having a different consecutive number of consecutive OFF pixels, and (ii) a size of a dither matrix used in the dithering.

Further features of the present invention will become apparent from the following description of exemplary embodiments (with reference to the attached drawings).

### BRIEF DESCRIPTION OF THE DRAWINGS

FIG. 1 is a cross-sectional view schematically illustrating an example of the hardware configuration of an image forming apparatus 9.

FIG. 2 is a block diagram illustrating an example of a configuration related to the processing of image signals in the image forming apparatus 9.

FIG. 3 is a block diagram illustrating an example of the internal configuration of a pixel counting unit 202.

FIG. 4 is a diagram illustrating an example of an image after dithering has been performed in an image signal generation unit 100.

FIG. 5 is a diagram illustrating an example of obtaining consecutive ON count values C1 to C5 in a dithering part.

FIG. 6 is a diagram illustrating an example of a correction coefficient used to determine a toner consumption amount.

FIG. 7 is a diagram illustrating an example of a pixel count value, a consecutive OFF count value, and a total number of OFF pixels.

FIG. 8 is a diagram illustrating an example of a prediction result and an actual measured result for the toner consumption amount.

FIG. 9 is a diagram illustrating an example of a flow for predicting a toner consumption amount (a second embodiment).

FIG. 10 is a diagram illustrating an example of a correction coefficient for the toner consumption amount (the second embodiment).

FIG. 11 is a diagram illustrating an example of an image corresponding to a VDO signal 110 generated by an image modulation unit 101 in a case where a toner saving mode is enabled (a third embodiment).

FIG. 12 is a diagram illustrating an example of a consecutive ON count value and a consecutive OFF count value determined through experimentation, for each of judgment consecutive numbers (a third embodiment).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

An electrophotographic laser beam printer (LBP) will be described as an example of an image forming apparatus according to embodiments of the present disclosure. However, the image forming apparatus is not intended to be limited to an LBP, and may be another type of image forming apparatus, such as a copier, a facsimile device, or the like.

### Configuration of Image Forming Apparatus

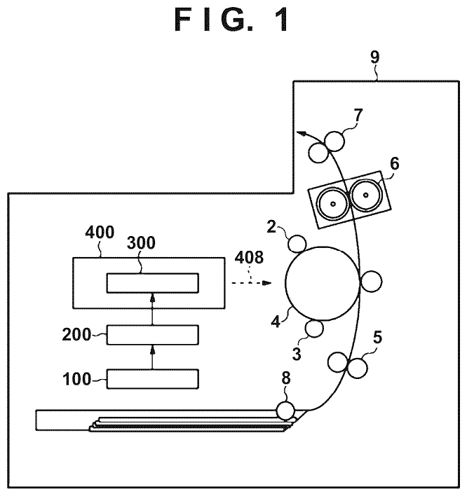

FIG. 1 is a cross-sectional view schematically illustrating the hardware configuration of an image forming apparatus 9 according to a first embodiment. The image forming apparatus 9 includes an image signal generation unit 100, a control unit 200, and an optical scanning unit 400. The optical scanning unit 400 includes a laser driving unit 300. The laser driving unit 300 in the optical scanning unit 400 outputs laser light (a light beam) 408 on the basis of an image signal output from the image signal generation unit 100 and a control signal output from the control unit 200. Although configured to form a monochromatic image using a single color of developer, such as a black developer (toner), the image forming apparatus 9 may be configured to form a multicolor image using yellow, magenta, cyan, and black developers, for example.

The image forming apparatus 9 includes an image forming unit constituted by an optical scanning unit 400, a photosensitive drum 4 (a photosensitive member), a charger 2, a developing unit 3, and the like. In an image forming process started by the control unit 200, the charger 2 charges the photosensitive drum 4. The optical scanning unit 400 forms an electrostatic latent image on the surface of the photosensitive drum 4 by scanning the surface of the photosensitive drum 4 (a scanned surface) with a laser beam based on an image signal (image data). The developing unit 3 forms a toner image (a developer image) on the photosensitive drum 4 by developing the electrostatic latent image formed on the photosensitive drum 4 using toner (a developer) held in a toner container (not shown) (that is, causing toner to adhere to the electrostatic latent image). In the present embodiment, the optical scanning unit 400 is an example of an exposure unit that forms an electrostatic latent image on a photosensitive member by exposing the photosensitive member on the basis of an image signal. The developing unit 3 is an example of a developing unit that forms a developer image on a photosensitive member by developing the electrostatic latent image using a developer (toner).

The toner image formed on the photosensitive drum 4 is conveyed to a transfer position at which the toner image is to be transferred to a recording medium, such as a sheet, as the photosensitive drum 4 rotates. The recording medium is conveyed from a sheet feed unit 8 in accordance with the timing at which the toner image is conveyed to the transfer position. The toner image formed on the photosensitive drum 4 is transferred to the recording medium, which has been fed and conveyed from the sheet feed unit 8 and for which skew has been corrected by a registration roller 5. The recording medium onto which the toner image has been transferred is conveyed to a fixer 6. The fixer 6 performs fixing processing for fixing the toner image onto the recording medium. The recording medium on which the fixing processing has been performed is discharged to the exterior of the image forming apparatus 9 (to a discharge tray) by a discharge roller 7.

### Configuration of Image Signal Generation Unit, Control Unit, and Laser Driving Unit

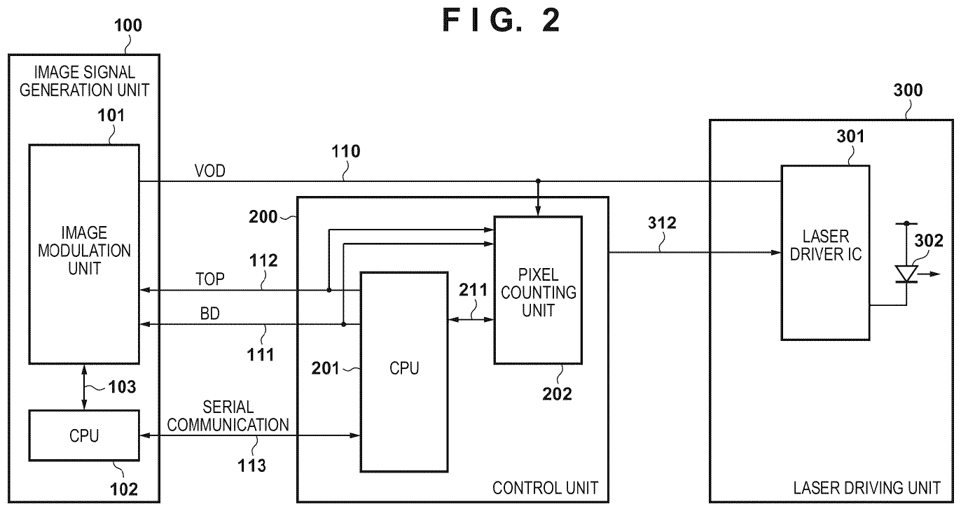

FIG. 2 is a block diagram illustrating an example of a configuration related to the processing of image signals in the image forming apparatus 9 according to the present embodiment. The image signal generation unit 100 receives print data from an external device (not shown), such as a host computer, and generates a VDO signal 110 (an image signal) on the basis of the received print data. The image signal generation unit 100 includes an image modulation unit 101 and a CPU 102. The VDO signal 110 output from the image signal generation unit 100 is input to the laser driving unit 300, and is also input to the control unit 200 (a pixel counting unit 202 within the control unit 200).

The control unit 200 includes a CPU 201 and the pixel counting unit 202. The CPU 201 controls the image forming apparatus 9. Referring to the input VDO signal 110, the pixel counting unit 202 performs counting processing regarding the presence/absence of pixels in the VDO signal 110 (the image signal). In the present embodiment, the CPU 201 is configured to obtain (predict) the amount of the developer (toner) consumed by the developing unit 3 on the basis of the VDO signal 110 (the image signal). The CPU 201 uses a count value output from the pixel counting unit 202 when obtaining the toner consumption amount.

The laser driving unit 300 includes a laser driver IC 301 and a laser 302. The laser 302 is constituted by a semiconductor laser, and is used as a light source for the laser driving unit 300. The laser driver IC 301 controls the emission of light by the laser 302 (on and off) on the basis of a laser control signal 312 output from the control unit 200 and the VDO signal 110 output from the image signal generation unit 100. The laser driver IC 301 forms an electrostatic latent image corresponding to the VDO signal 110 on the photosensitive drum 4 by irradiating the scanned surface of the photosensitive drum 4, which has been charged in advance, with the laser beam output from the laser 302.

### Pixel Counting Unit

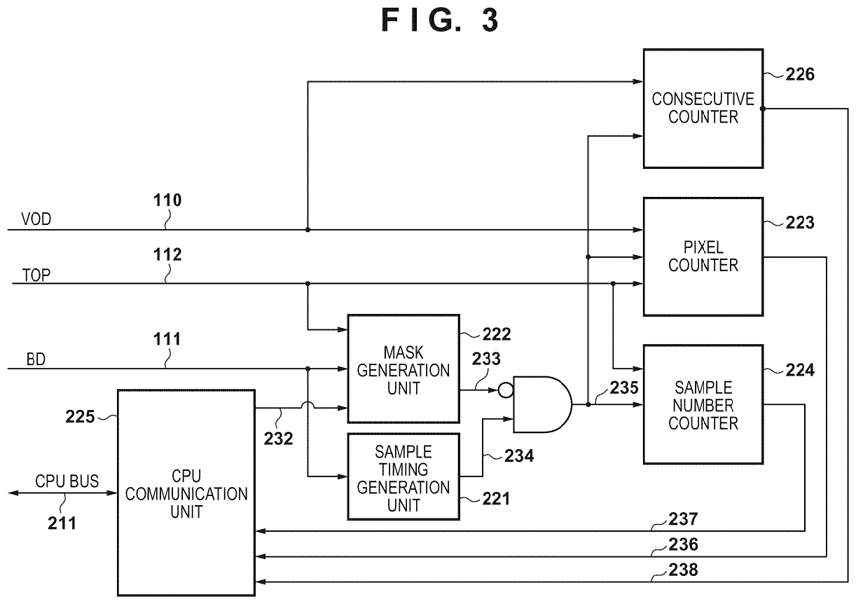

FIG. 3 is a block diagram illustrating an example of the internal configuration of the pixel counting unit 202. The pixel counting unit 202 includes a sample timing generation unit 221, a mask generation unit 222, a pixel counter 223, a sample number counter 224, a CPU communication unit 225, and a consecutive counter 226.

The CPU communication unit 225 communicates with the CPU 201 over a CPU bus 211. The CPU communication unit 225 sends each of count values output from the sample number counter 224, the pixel counter 223, and the consecutive counter 226 to the CPU 201. The CPU communication unit 225 sends various setting values received from the CPU 201 to the sample timing generation unit 221 and the mask generation unit 222. The various setting values include image mask settings 232 sent to the mask generation unit 222. The image mask settings 232 include information indicating the start and end timings of a sub-scanning mask using a TOP signal 112 as a reference, and information indicating the start and end timings of a main scanning mask using a BD signal 111 as a reference. In the present embodiment, the counting processing executed by the pixel counting unit 202 is executed in an image region excluding regions corresponding to the aforementioned sub-scanning mask and main scanning mask. The BD signal 111 and the TOP signal 112 are generated by the CPU 201, and are supplied to the image modulation unit 101 and the pixel counting unit 202.

The sample timing generation unit 221 (a clock signal generation unit) generates and outputs a sample timing signal (a sampling clock signal) 234 to be sent to the pixel counter 223, the sample number counter 224, and the consecutive counter 226. The sample timing signal 234 is output at a constant period. The present embodiment assumes that the pixel sample timing period is set to 50 MHz, and that an image clock period for forming one pixel is also set to 50 MHz. In other words, a single pixel sample timing occurs for a single pixel.

The mask generation unit 222 sets a mask signal 233 to “low” level in a region (an image region) where an image is formed (rendered) in accordance with the image mask settings 232, using the TOP signal 112 and the BD signal 111 as a reference. The sample timing signal 234 is supplied to the pixel counter 223, the sample number counter 224, and the consecutive counter 226 as a sample timing signal 235 in the image region during a period in which the mask signal 233 is set to “low” level (i.e., while the image is being rendered).

The pixel counter 223 includes a counter for counting effective pixels of the VDO signal 110 (ON pixels, which are pixels where toner is expected to adhere), and outputs a pixel count value 236 obtained by counting the ON pixels. Upon receiving the TOP signal 112 (a sub-scanning synchronization signal), the pixel counter 223 clears the pixel count value 236 held therein to 0. The pixel counter 223 increases the pixel count value 236 by 1 when the sample timing signal 235 indicating the sample timing of the pixels in the image region is at “high” level and the VDO signal 110 is also at “high” level. In other words, the pixel counter 223 counts the “high” level VDO signal 110 (i.e., counts the ON pixels) using the sample timing signal 235 as a synchronization signal.

The sample number counter 224 includes a counter for counting a number of times the sample timing signal 235 is received in the image region. The sample number counter 224 outputs a sample number count value 237 obtained by counting the number of times the sample timing signal 235 (a “high” level signal) is received in the image region. Upon receiving the TOP signal 112 (the sub-scanning synchronization signal), the sample number counter 224 clears the sample number count value 237 held therein to 0. The sample number counter 224 increases the sample number count value 237 by 1 when the sample timing signal 235 indicating the sample timing of the pixels in the image region is at “high” level.

### Consecutive Counter

Using the input sample timing signal 235 as a reference, the consecutive counter 226 increases a consecutive count value 238 by 1 when pixels are counted consecutively in the VDO signal 110 by a pre-set consecutive number for judgment (a judgment consecutive number). For example, if the judgment consecutive number is set to 5, the consecutive counter 226 increases the consecutive count value 238 by 1 when a pixel has been counted five times consecutively.

The consecutive counter 226 is configured to be capable of counting the number of consecutive “high” levels in the VDO signal 110 (i.e., counting ON pixels) and the number of consecutive “low” levels in the VDO signal 110 (i.e., counting OFF pixels). The consecutive counter 226 outputs a consecutive ON count value obtained by counting the consecutive “high” levels in the VDO signal 110 with respect to the pre-set consecutive number for judgment (the judgment consecutive number). The consecutive counter 226 also outputs a consecutive OFF count value obtained by counting the consecutive “low” levels in the VDO signal 110 with respect to the judgment consecutive number. In the present embodiment, the counting processing is performed by the consecutive counter 226 for the VDO signal 110, and thus pixels which are consecutive in the main scanning direction (ON pixels or OFF pixels) are counted.

In the present embodiment, the consecutive counter 226 is configured to output a count value (consecutive OFF count value) obtained by individually counting OFF pixel groups included in the image corresponding to the VDO signal 110 (the image signal), each OFF pixel group being constituted by consecutive OFF pixels and having a different consecutive number of consecutive OFF pixels. The consecutive counter 226 may further be configured to output a count value (consecutive ON count value) obtained by individually counting ON pixel groups included in the image corresponding to the VDO signal 110 (the image signal), each ON pixel group being constituted by consecutive ON pixels and having a different consecutive number of consecutive ON pixels.

### Dithering

In the image forming apparatus 9 according to the present embodiment, the image signal generation unit 100 is configured to generate the VDO signal 110 (the image signal) by performing halftone processing (dithering) on an input image using a dithering method. The image information of the input image is constituted by, for example, pixel values (tone values) in which each pixel has 8 bits. The tone of the input image is corrected through the dithering. The tone correction is performed to correct gamma characteristics according to the state of the image forming apparatus 9 and form a good halftone in output images.

The image signal that has undergone dithering by the CPU 102 is modulated into the VDO signal 110 by the image modulation unit 101. The VDO signal 110 generated by the image modulation unit 101 is supplied to the laser driving unit 300 and the control unit 200.

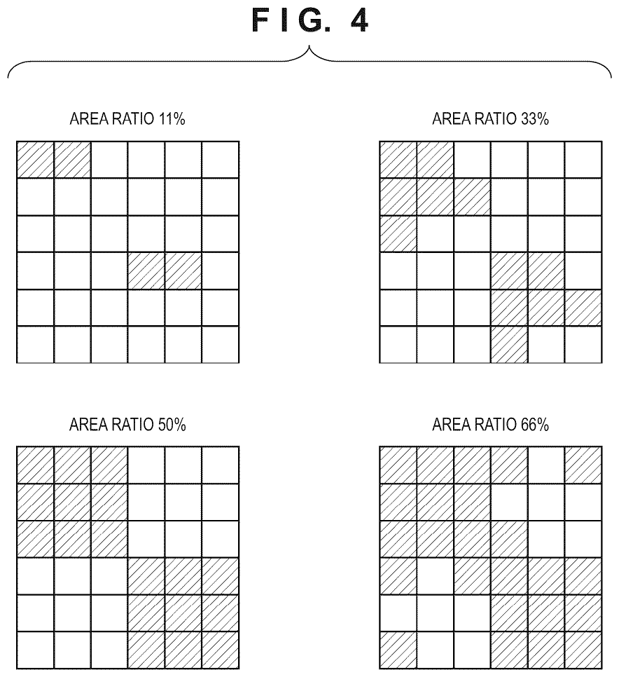

FIG. 4 illustrates an example of an image (dither matrix) after dithering has been performed by the image signal generation unit 100 according to the present embodiment. This example illustrates the image when dithering is performed at area ratios of 11%, 33%, 50%, and 66%. As illustrated in FIG. 4, the CPU 102 forms a tone image by repeatedly arranging dither matrices that are six vertical pixels by six horizontal pixels.

As illustrated in FIG. 4, in the post-dithering image, the consecutive count value of the ON pixels changes in a complicated manner in response to changes in the area ratio. Specifically, in a case where the area ratio is 11%, only instances of two consecutive ON pixels (ON pixel groups having a consecutive number of 2) arise, whereas in a case where the area ratio is 33%, instances of one to three consecutive ON pixels (ON pixel groups having a consecutive number of 1 to 3) arise. In a case where the area ratio is 50%, only instances of three consecutive ON pixels (ON pixel groups having a consecutive number of 3) arise, whereas in a case where the area ratio is 66%, instances of one to five consecutive ON pixels (ON pixel groups having a consecutive number of 1 to 5) arise.

In the present embodiment, the pixel sample timing period is set to be the same as the image clock period. Accordingly, the consecutive number of pixels (ON pixels) is counted (obtained) as the consecutive ON count value.

### Predicted Value for Consecutive ON Count Value

In the image forming apparatus 9 according to the present embodiment, a predicted value for the consecutive ON count value is obtained (calculated) using the consecutive OFF count value and the size of the dither matrix for a processing region where the dithering is performed (a dithering part). The “size of the dither matrix” refers to the size of a basic unit of dithering in which pixel groups in the vertical direction and the horizontal direction are repeatedly arranged in a set pattern as a result of dithering. In the present embodiment, pixel counting processing is performed by the pixel counting unit 202 on the basis of the VDO signal 110, as described above. Accordingly, the size of the dither matrix in the main scanning direction (the horizontal direction) is used to calculate the predicted value for the consecutive ON count value.

The predicted value for the consecutive ON count value is calculated as follows, for example:

$$( size of dither matrix \times pixel sample timing period / image clock period ) - consecutive OFF count value .$$

Note that a method other than this calculation method may be used as long as a value similar to the consecutive ON count value is ultimately obtained using the repetitiveness of the dither matrix used for dithering and the size of the dither matrix.

In an image in which dithering (halftone processing) is performed, the majority of the consecutive OFF pixels in the image generally correspond to a consecutive number that is smaller than the size of the dither matrix used for dithering. This is because there are almost no images where small, set blanks (spaces at the pixel level) are created intentionally, and the occurrence of repetitions of consecutive OFF pixels due to dithering becomes dominant. Accordingly, the consecutive ON count value (the predicted value) in the dithering part is also smaller than the size of the dither matrix used for the dithering.

The present embodiment will describe a method for correcting the toner consumption amount using the consecutive ON count value in a dithering part that is smaller than the size of the dither matrix used for dithering.

### Method for Correcting Toner Consumption Amount

In the present embodiment, the pixel counting unit 202 (the consecutive counter 226) sets the consecutive number for judgment (the judgment consecutive number) for obtaining the consecutive OFF count value, to a number smaller than the size of the dither matrix. In this example, a dither matrix having a size of six horizontal pixels and six vertical pixels is used for dithering, as illustrated in FIG. 4. Accordingly, five consecutive numbers smaller than the size of the dither matrix, namely 1, 2, 3, 4, and 5, are set at the judgment consecutive numbers for the consecutive OFF count value. The pixel counting unit 202 (the consecutive counter 226) is configured to obtain the consecutive OFF count value corresponding to each of the judgment consecutive numbers set. The judgment consecutive numbers for the consecutive ON count value (the predicted value) in the dithering part are set to values obtained by subtracting the judgment consecutive numbers for the consecutive OFF count value from the size of the dither matrix (that is, 5, 4, 3, 2, and 1). In the following, the consecutive ON count values in the dithering part, corresponding to the judgment consecutive numbers 5, 4, 3, 2, and 1, are represented by C5, C4, C3, C2, and C1, in that order.

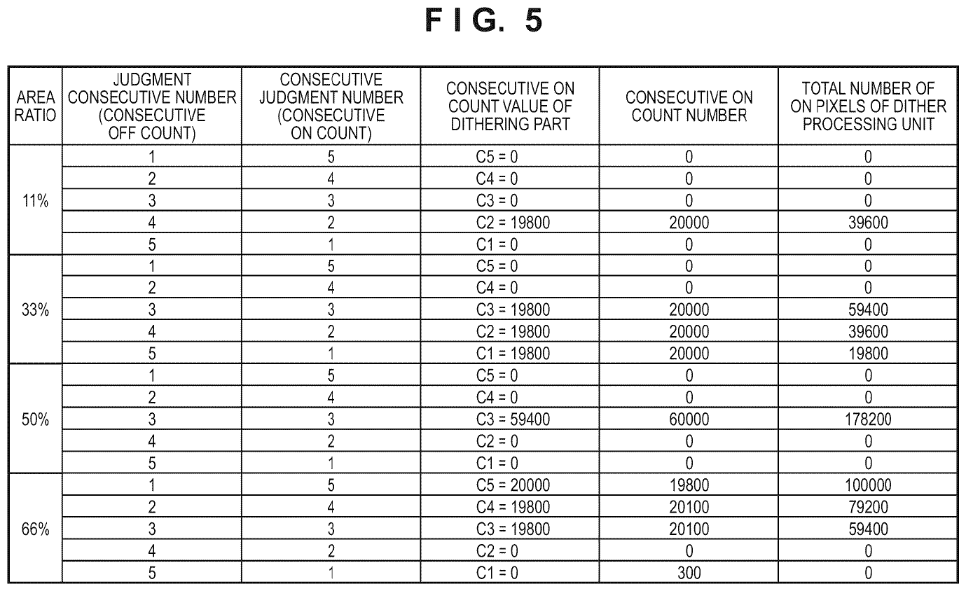

Here, the consecutive ON count value (the predicted value) in the dithering part is compared with the consecutive ON count value obtained by counting the actual consecutive ON pixels, using an image in which only halftone processing is performed. FIG. 5 illustrates an example of obtaining the consecutive ON count values C1 to C5 in the dithering part. In this example, images obtained by arranging 100 of the post-dithering images at each area ratio, illustrated in FIG. 4, in a repeating manner in both the vertical direction (the direction orthogonal to the main scanning direction) and the horizontal direction (the main scanning direction), are subjected to the counting processing. For example, if the length of one side of one (square) pixel is approximately 42.3 μm, a square image 25.4 mm long on each side becomes the image to be processed.

As illustrated in FIG. 5, error between the consecutive ON count values (predicted values) C1 to C5 in the dithering part and the actual consecutive ON count values is low, regardless of the area ratio. In this manner, the consecutive ON count value (predicted value) obtained from the consecutive OFF count value and the size of the dither matrix can be used, instead of the actual consecutive ON count value, to correct the toner consumption amount, even for the post-dithering image that is approximately 25.4 mm in size. The stated error may be caused by the part at which the repeated dithering starts or ends. As such, the error can become lower as the image region to be subjected to halftone processing (dithering) becomes larger.

In a region, in the image corresponding to the VDO signal 110, aside from the dithering part, such as a text part or the like, the consecutive ON count value increases more than in the dithering part, but the consecutive OFF count value increases almost not at all. On the other hand, in the dithering part, it can be said that it is more suitable, in terms of improving the prediction accuracy, to use the consecutive ON count value (the predicted value) obtained from the consecutive OFF count value and the size of the dither matrix to correct (predict) the toner consumption amount, than the actual consecutive ON count value.

In the present embodiment, the toner consumption amount is corrected (predicted) by applying a correction coefficient for the toner consumption amount to each of the ON pixels in the image corresponding to the VDO signal 110. To that end, the total number of ON pixels in the dithering part is determined on the basis of the consecutive ON count values (the predicted values) in the dithering part. Specifically, the total number of ON pixels in the dithering part can be determined by multiplying the consecutive ON count values C1 to C5 in the dithering part by the corresponding judgment consecutive numbers (i.e., C5×5, C4×4, C3×3, C2×2, and C1×1).

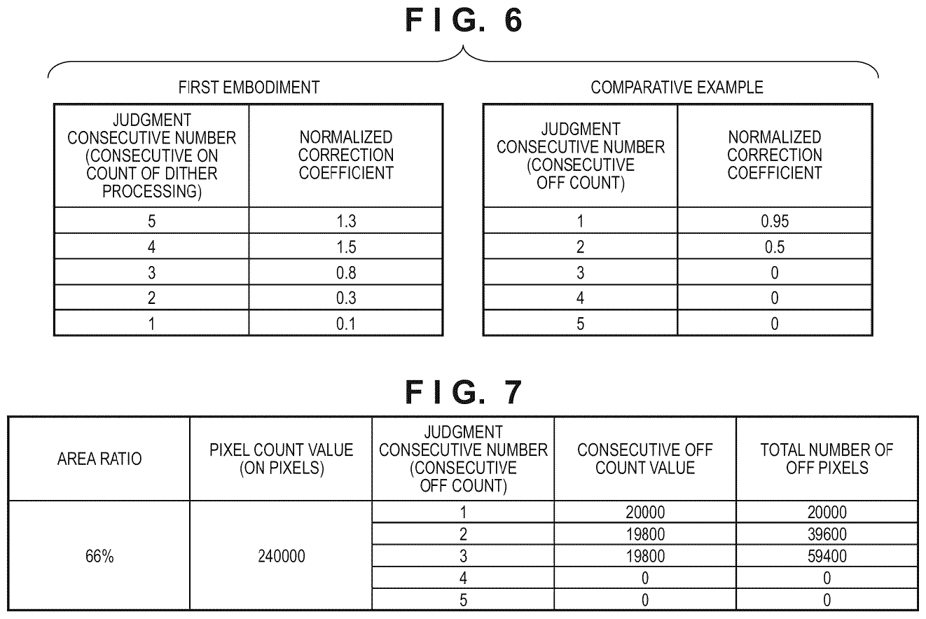

FIG. 6 is a diagram illustrating an example of a correction coefficient used to determine the toner consumption amount when forming a target image, in the present embodiment and in a comparative example. The correction coefficient in the present embodiment and the comparative example is a value obtained by normalizing a consumption amount per pixel, in a vertical line image in which six ON pixels and 144 OFF pixels are repeated in the vertical direction, to 1. This image is used as a reference image for normalizing the toner consumption amount. The correction coefficient for the toner consumption amount per pixel in the reference image is taken as a normalized correction coefficient. By performing such normalization, the unit of the toner consumption amount becomes the number of pixels in the reference image.

In the present embodiment, the toner consumption amount is predicted by multiplying the total number of ON pixels based on the predicted value for the consecutive ON count value in the dithering part by the normalized correction coefficient for each judgment consecutive number, and further obtaining the sum of the values obtained for each judgment consecutive number. The sum obtained in this manner is obtained as a predicted toner consumption amount (the predicted value of the toner consumption amount) in the dithering part.

For example, for the area ratio of 33% in FIGS. 4 and 5, the predicted toner consumption amount for the post-dithering image is calculated as follows:

$$0 \times 1.3 + 0 \times 1.5 + 59400 \times 0.8 + 39600 \times 0.3 + 19800 \times 0.1 = 61380$$

Here, the pixel count value (i.e., the total number of ON pixels in the target image) is 120000 (when obtained from the consecutive ON count value indicated in FIG. 5), and thus the normalized consumption amount is 61380/120000=0.512. According to this normalized consumption amount, a prediction result of approximately half the toner consumption amount per pixel can be obtained for the reference image.

It should be noted that the consecutive OFF count value becomes extremely low when the area ratio approaches 100%, and error in the calculation for predicting the toner consumption amount can become high. Accordingly, for example, when at least 90% of the OFF pixels in the dithering part are single (non-consecutive) OFF pixels, correcting the toner consumption amount using the correction coefficient may be skipped.

On the other hand, in the comparative example, the toner consumption amount is corrected using the consecutive OFF count value for each judgment consecutive number. As a result, the toner consumption amount is corrected for situations where the spacing between ON pixels is narrow and toner is deposited even in parts corresponding to OFF pixels (in the periphery of the ON pixels). The correction coefficients (normalized correction coefficient) in the comparative example indicated in FIG. 6 were obtained by measuring the toner consumption amount while changing the spacing between lines constituted by six pixels in the vertical direction (OFF pixel spacing). The correction coefficients in FIG. 6 are correction coefficients applied to a single OFF pixel. In the comparative example, the predicted toner consumption amount is obtained as (ON pixel count value+predicted value of toner consumption amount for OFF pixels).

When predicting the toner consumption amount based on the OFF pixels, the total number of OFF pixels corresponding to each judgment consecutive number is determined as (the consecutive OFF count value×the judgment consecutive number). Furthermore, the predicted value for the toner consumption amount based on the OFF pixels is obtained by multiplying the correction coefficient indicated in FIG. 6 by the total number of OFF pixels for each judgment consecutive number, and obtaining the sum of the resulting values.

FIG. 7 is a diagram illustrating an example of a pixel count value, consecutive OFF count values, and total numbers of OFF pixels, obtained using a post-dithering image having the area ratio of 66% in FIG. 4. The total number of OFF pixels is determined by multiplying the judgment consecutive number by the consecutive OFF count value. According to the example in FIG. 7, the predicted value for the toner consumption amount based on the OFF pixels is obtained as 20000×0.95+39600×0.5+59400×0+0×0+0×0=38800, using the correction coefficient indicated in FIG. 6. Furthermore, the predicted toner consumption amount is obtained as 240000+38800=278800. The normalized consumption amount is therefore 278800/240000=1.162. In this manner, when a post-dithering image having the area ratio of 66% in FIG. 4 is formed, a prediction result indicating that a large amount of toner will be consumed is obtained for about 10% of the reference image.

### Prediction Accuracy

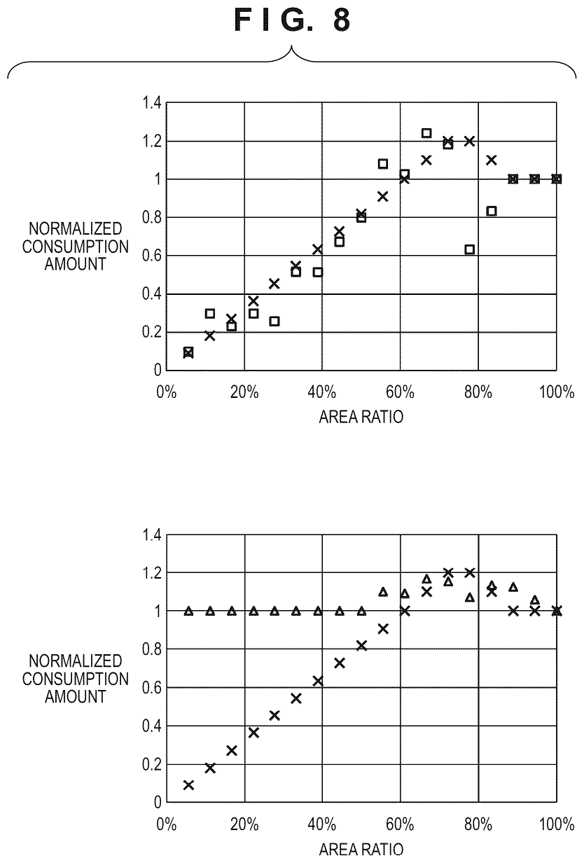

The accuracy of predicting the toner consumption amount according to the present embodiment and the comparative example will be described next. FIG. 8 illustrates an example of a prediction result and an actual measured result for the toner consumption amount according to the present embodiment and the comparative example. FIG. 8 illustrates results obtained from the following experiments. In accordance with the growth of a dither matrix having a size of six horizontal pixels and six vertical pixels, 18 patterns of images obtained by increasing the area ratio by 100/18 (≈5.55) % each were prepared (images having 5100 horizontal pixels and 6400 vertical pixels). Furthermore, a measurement value of the toner consumption amount was obtained by outputting (printing) the images on 200 sheets of a letter-size recording medium, respectively, and calculating the toner consumption amount per ON pixel on the basis of a toner decrease amount between before and after the output. The average value of the predicted value (the predicted toner amount) calculated through the above-described method was obtained to predict the toner consumption amount.

In the graph in FIG. 8, the horizontal axis represents the area ratio of the input image, and the vertical axis represents the normalized consumption amount (for one pixel). The plots indicated by squares represent the predicted values in the present embodiment, and the plots indicated by triangles represent the predicted values in the comparative example. The plots indicated by X represent values obtained by normalizing the toner consumption amount actually measured in the image forming apparatus 9. Note that as described above, 18 patterns of images having different area ratios are used as the input images. A normalized consumption amount of 1 means that the amount is equivalent to the toner consumption amount in the reference image (for one pixel). A normalized consumption amount lower than 1 means that the amount is less than the toner consumption amount in the reference image (for one pixel). A normalized consumption amount greater than 1 means that the amount is greater than the toner consumption amount in the reference image (for one pixel).

The predicted value for the toner consumption amount in the comparative example (the normalized consumption amount) is 1 because there is sufficient pixel spacing up to an area ratio of approximately 50% in the input image. As the area ratio of the input image increases further from around 60%, a predicted value close to the measured value of the actual toner consumption amount is obtained on the basis of the tendency for toner to adhere to OFF pixels. In the comparative example, the mean absolute error (MAE) between the predicted value and the measured value of the toner consumption amount is 0.313 overall.

The predicted value of the toner consumption amount in the present embodiment increases as the area ratio of the input image increases, up to an area ratio of approximately 70%. This is the same as the measured value of the actual toner consumption amount, and means that a high prediction accuracy is achieved. However, when the area ratio of the input image increases to approximately 80%, the error between the predicted value and the measured value increases. This is because the prediction accuracy drops due to fewer OFF pixels being included in the input image. Furthermore, in the range of area ratios from approximately 90% to 100% in the input image, the predicted value is 1, which is almost the same as the measured value. This is because when the area ratio is at least 90%, a condition for not correcting the toner consumption amount using the correction coefficient is satisfied, and the toner consumption amount is therefore not corrected using the correction coefficient as described above.

In the present embodiment, the MAE between the predicted value and the measured value of the toner consumption amount is 0.101 overall. In this manner, predicting the toner consumption amount according to the present embodiment makes it possible to reduce the MAE between the predicted value and the measured value of the toner consumption amount compared to the comparative example, which in turn makes it possible to improve the prediction accuracy.

Note that the decrease in the prediction accuracy of the toner consumption amount in the comparative example is caused by the fact that the drop in the toner consumption amount for ON pixels in the dithering part cannot be corrected by correcting the toner consumption amount based on the OFF pixels. When a blank part where pixels are not formed (where no toner adheres) is large, the correction coefficient can be set to a negative value. However, using a correction coefficient inconsistent with the physical phenomenon to be predicted may lead to a further drop in the prediction accuracy. The accuracy of predicting the toner consumption amount for ON pixels can also be improved by configuring the circuitry to also obtain the consecutive ON count value, at the expense of increasing the cost of the circuitry in the apparatus. In this case, the prediction accuracy can be improved by also using the consecutive ON count value (the prediction value) in the dithering part, as in the present embodiment. This is because appropriate correction coefficients can be set for corresponding regions in the input image, such as the dithering part and text parts aside from the dithering part, using the consecutive ON count value (the predicted value) and the actual consecutive ON count value in the dithering part. (On this point, see the second embodiment as well.)

As described above, in the image forming apparatus 9 according to the present embodiment, the image signal generation unit 100 generates an image signal (the VDO signal 110) by performing dithering as halftone processing on an input image. The control unit 200 obtains (predicts) a consumption amount of the developer for forming a developer image, on the basis of the image signal. The control unit 200 obtains the consumption amount of the developer using (i) a count value obtained by individually counting OFF pixel groups included in an image corresponding to the image signal, each OFF pixel group being constituted by consecutive OFF pixels and having a different consecutive number of consecutive OFF pixels (the consecutive OFF count value), and (ii) a size of a dither matrix used in the dithering.

More specifically, the control unit 200 obtains a difference between the size of the dither matrix and the count value for the OFF pixel group corresponding to each of consecutive numbers (the consecutive OFF count value) as a count value for an ON pixel group having a corresponding consecutive number of consecutive ON pixels (the consecutive ON count value) in a processing region of the image on which the dithering is to be performed. The control unit 200 further obtains the consumption amount of the developer on the basis of the count value for the ON pixel group corresponding to each consecutive number.

In this manner, the consecutive ON count value corresponding to each consecutive number in the dithering part is found using the size of the dither matrix used in the dithering and the consecutive OFF count value, and the consumption amount of the developer is obtained (predicted) on the basis of the consecutive ON count value. This makes it possible to more appropriately correct the consumption amount of the developer using the correction coefficient in accordance with the consecutive number (size) of the ON pixel group, which in turn makes it possible to obtain (predict) the consumption amount more accurately. Therefore, according to the present embodiment, it is possible to prevent a drop in the accuracy of predicting the consumption amount of the developer (toner) in a case of performing dithering on an input image.

For example, as the correction coefficient, a small correction coefficient is set for an ON pixel group having a small consecutive number, and a large correction coefficient is set for an ON pixel group having a large consecutive number. For the ON pixel group, the control unit 200 applies the correction coefficient corresponding to such an individual consecutive number to the total number of ON pixels obtained on the basis of the count value corresponding to the individual consecutive number. Furthermore, the control unit 200 obtains a sum of consumption amounts corresponding to the individual consecutive numbers for the ON pixel group, as the consumption amount of the developer for forming the developer image. Correction using such a correction coefficient makes it possible to improve the accuracy of predicting the consumption amount of the developer.

Additionally, in the present embodiment, the consumption amount of the developer can be obtained using only the count value for the OFF pixel group corresponding to a consecutive number smaller than the size of the dither matrix. Accordingly, the present embodiment has an additional advantage in that it is not necessary to obtain the consecutive OFF count value corresponding to larger consecutive numbers in order to capture the characteristics of the image. Note that for regions other than the dithering part in the image corresponding to the image signal, another consecutive OFF count value may be additionally used to correct the consumption amount of the developer. In this case, the correction is applied to pixels having a count number obtained by subtracting the pixel count number in the dithering part from the pixel count number of the overall image.

Although the present embodiment uses the correction coefficient to weight the consecutive ON count value (predicted value) corresponding to each consecutive number in the dithering part to correct the consumption amount of the developer, a different algorithm may be used instead.

### Second Embodiment

A second embodiment will describe an example in which, in addition to the configuration described in the first embodiment, the consumption amount of the developer (toner) for forming the developer image (toner image) is obtained more accurately by further using the consecutive ON count value. The following will omit descriptions of portions that are the same as in the first embodiment, and will only describe portions that are different from those in the first embodiment.

In the pixel counting unit 202 according to the present embodiment, values smaller and larger than the size of the dither matrix are set as judgment consecutive numbers N for the consecutive ON count value. As an example, In a case where the size of the dither matrix is set to 6, five values, namely N=1, 2, 3, 4, and 5, are set as judgment consecutive numbers N smaller than the size of the dither matrix. In addition, five values, namely N=6, 7, 8, 9, and 10, are set as judgment consecutive numbers N larger than the size of the dither matrix (for a total of ten values). The consecutive ON count values corresponding to these ten judgment consecutive numbers N are taken as D1 to D10, in order.

The consecutive ON count value in a region other than the dithering part can be obtained by finding the difference between the consecutive ON count values D1 to D5 and the predicted value for the consecutive ON count value in the dithering part for the judgment consecutive numbers N of 1 to 5. In this case, the correction coefficient can be applied individually to the toner consumption amount obtained on the basis of the consecutive ON count value for the dithering part and to the toner consumption amount obtained on the basis of the consecutive ON count value for the region other than the dithering part (e.g., small dot or fine line regions can be separated, and the correction coefficient can be applied to those regions). This makes it possible to improve the accuracy of predicting the toner consumption amount.

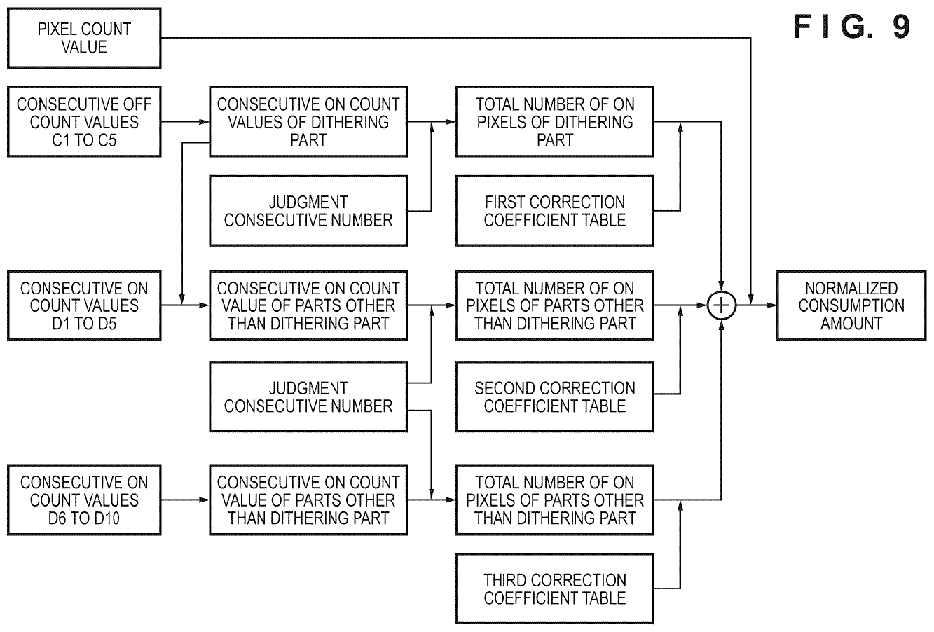

FIG. 9 illustrates an example of a flow for predicting the toner consumption amount in the present embodiment. The prediction of the toner consumption amount is performed by the CPU 201 in the control unit 200. As illustrated in FIG. 9, on the basis of the consecutive OFF count values C1 to C5, a predicted value of the consecutive ON count value in the dithering part is obtained through the same procedure as in the first embodiment, and a toner consumption amount corrected using a first correction coefficient table is obtained.

Additionally, on the basis of the consecutive ON count values D1 to D5, consecutive ON count values corresponding to the ON pixel groups having consecutive numbers smaller than the size of the dither matrix in the region other than the dithering part in the input image are obtained, as described above. Furthermore, by multiplying each of the obtained consecutive ON count values by the judgment consecutive number corresponding thereto, the total number of corresponding ON pixels is obtained. Thereafter, the total number of ON pixels (equivalent to the toner consumption amount) corresponding to each of the different judgment consecutive numbers is multiplied by a correction coefficient included in a second correction coefficient table. By obtaining the sum of the obtained values, a corrected toner consumption amount, which corresponds to the ON pixel group having a consecutive number smaller than the size of the dither matrix, is obtained.

Furthermore, the consecutive ON count values D6 to D10 correspond to the consecutive ON count values corresponding to the ON pixel groups having consecutive numbers larger than the size of the dither matrix in the region other than the dithering part in the input image. By multiplying each of the consecutive ON count values D6 to D10 by the judgment consecutive number corresponding thereto, the total number of corresponding ON pixels is obtained. Thereafter, the total number of ON pixels (equivalent to the toner consumption amount) corresponding to each of the different judgment consecutive numbers is multiplied by a correction coefficient included in a third correction coefficient table. By obtaining the sum of the obtained values, a corrected toner consumption amount, which corresponds to the ON pixel group having a consecutive number larger than the size of the dither matrix, is obtained.

In the present embodiment, correction coefficients suited to the dithering part, the ON pixel groups having small consecutive numbers in the region other than the dithering part, and the ON pixel groups having large consecutive numbers in the region other than the dithering part are set in advance in the stated first to third correction coefficient tables. Finally, the normalized consumption amount is obtained by dividing the sum of the three obtained toner consumption amounts by the pixel count value.

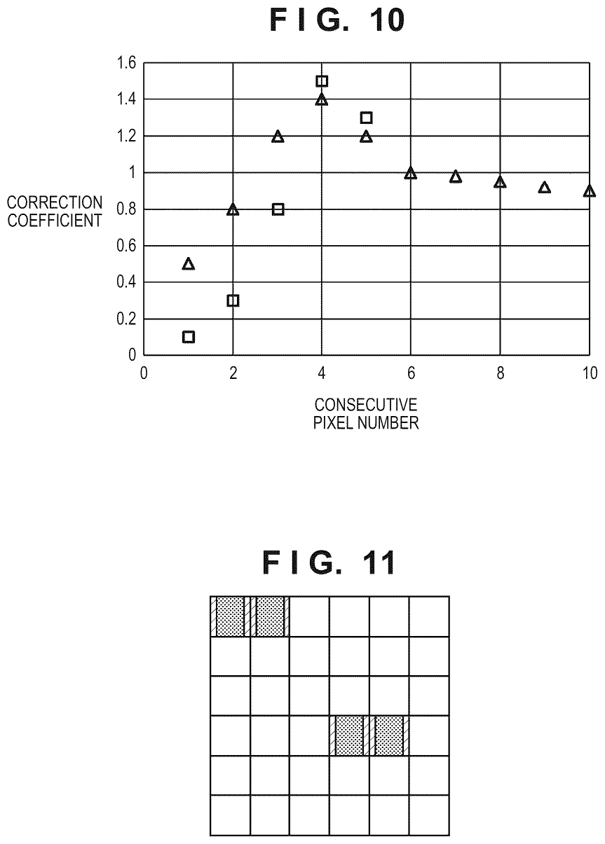

FIG. 10 illustrates an example of correction coefficients for the toner consumption amount obtained by experiments on a dithering part (a post-dithering image) and a vertical line image. In this experiment, the same experiment as that described in the first embodiment was performed on the dithering part. However, for the vertical line image, ten vertical line images were prepared, in which one to ten consecutive ON pixels and 144 consecutive OFF pixels were repeated. The images to be processed were images having 5100 horizontal pixels and 6400 vertical pixels.

In the graph of FIG. 10, the horizontal axis represents a consecutive pixel number (number of consecutive pixels), and the vertical axis represents the correction coefficient for the toner consumption amount. The plots indicated by squares represent the correction coefficients for the dithering part, and the plots indicated by triangles represent the correction coefficients for the line image. As illustrated in FIG. 10, for each consecutive pixel number, the correction coefficient for the dithering part and the correction coefficient for the line image have different values. This indicates that the correction coefficient suitable for correcting the toner consumption amount is different for the post-dithering image and the line image, even if the consecutive number of ON pixels is the same. If the consecutive ON count value (predicted value) obtained from the consecutive OFF count value is not used in the dithering part, it is necessary to select one of the correction coefficients or use an intermediate value therebetween to correct the toner consumption amount based on the consecutive ON count value. This may lead to a drop in the accuracy of the prediction.

In the experiment performed in the present embodiment, the images were prepared such that the post-dithering image and the vertical line image have the same number of pixels. The post-dithering image was an image having an area ratio of 11%, and the vertical line image was an image in which two ON pixels and 144 OFF pixels are repeated. The normalized consumption amount for the toner consumption amount for these images was 0.6. The normalized consumption amount (predicted value) obtained by predicting the toner consumption amount according to the present embodiment was 0.55. On the other hand, when the correction coefficient was applied only to the toner consumption amount based on the consecutive ON count value, the normalized consumption amount (predicted value) was 0.8. In this manner, the accuracy of predicting the toner consumption amount can be improved by appropriately applying the correction coefficient for the toner consumption amount to both the post-dithering image and the line image.

As described above, in the image forming apparatus 9 of the present embodiment, the control unit 200 obtains the consumption amount of the developer (toner) using (i) a count value obtained by individually counting OFF pixel groups included in an image corresponding to the image signal and having different consecutive numbers (the consecutive OFF count value), (ii) a count value obtained by individually counting ON pixel groups having different consecutive numbers (the consecutive ON count value), and (iii) a size of a dither matrix used in the dithering. Also using the consecutive ON count value in this manner makes it possible to correct the consumption amount of the developer by applying the correction coefficient individually to the dithering part and other regions in the image corresponding to the image signal. This makes it possible to obtain (predict) the consumption amount more accurately. Therefore, according to the present embodiment, it is possible to prevent a drop in the accuracy of predicting the consumption amount of the developer (toner) when performing dithering on an input image.

### Third Embodiment

The present embodiment will describe an example in which the image signal generation unit 100 is configured to generate an image signal in which each of the pixels developed by the developing unit 3 is partially thinned. The following will omit descriptions of portions that are the same as in the first embodiment, and will only describe portions that are different from those in the first embodiment.

### Processing for Thinning Parts of Pixels

As an operating mode that can be set for image forming, the image forming apparatus 9 according to the present embodiment has a toner saving mode for reducing the toner consumption amount. In the present embodiment, the toner consumption amount is reduced by the image signal generation unit 100 generating the VDO signal 110 such that each of the pixels (the ON pixels) is partially thinned. For example, the thinning is performed (the laser 302 is not emitted by the laser driving unit 300) in a region of 10% at both ends of each pixel in the main scanning direction. As a result, the time of emission by the laser 302 for each pixel in the input image drops to 80%, which reduces the toner consumption amount for each pixel.

FIG. 11 illustrates an example of an image corresponding to the VDO signal 110 generated by an image modulation unit 101 when the toner saving mode is enabled. In this example, it can be seen that the thinning has been performed on the post-dithering image having an area ratio of 11%, illustrated in FIG. 4, and that the thinning has been applied to both ends of each ON pixel in the main scanning direction.

In the present embodiment, the image clock period is set to 50 MHz, whereas the pixel sample timing period is set to 80 MHz, for example. The number of pixels not counted may rise to an extreme level if the thinning described above is performed in a state where the pixel sample timing period and the image clock period are the same. Accordingly, in the present embodiment, the pixel sample timing period is set to be higher than the image clock period, such that each pixel is counted at least once.

### Counting Processing When Applying Thinning

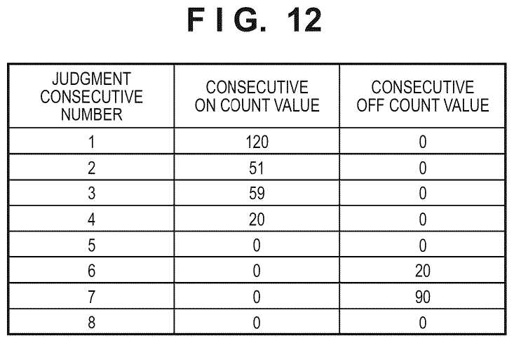

An example of the consecutive ON count value and the consecutive OFF count value obtained through the counting processing on an input image to which the stated thinning has been applied will be described next. FIG. 12 illustrates an example of a consecutive ON count value and a consecutive OFF count value determined through experimentation, for each of judgment consecutive numbers. An image in which 100 pixel groups were arranged, each constituted by four consecutive pixels, was used in this experiment.

If no thinning is performed on the input image, under conditions where the image clock period is 50 MHz and the pixel sample timing period is 80 MHz, the ON pixel group corresponding to a judgment consecutive number of 6 or 7 is counted, and the average consecutive ON count value becomes 6.4. However, it is also desirable to obtain the same value as the average consecutive ON count value when thinning is performed on the input image.

As illustrated in FIG. 12, the consecutive ON pixel groups that are counted are the pixel groups for which the judgment consecutive number is 1 to 4. This is because the pixel sample timing overlaps at the positions where the thinning is performed, thereby ending the consecutive counting of the ON pixels. In this case, the toner consumption amount cannot be corrected on the basis of the desired consecutive ON count value, and the appropriate correction coefficient also cannot be set.

On the other hand, when obtaining the consecutive OFF count value, the OFF pixels are already being counted, and the process is therefore less susceptible to the effects of thinning parts of the pixels. Accordingly, in the present embodiment, even if the image forming apparatus 9 is configured to perform the thinning described above, the toner consumption amount is predicted by obtaining the consecutive ON count value from the consecutive OFF count value, which makes it possible to prevent a drop in the prediction accuracy.

Although the present embodiment describes the toner saving mode as an example of performing the thinning described above, it should be noted that the thinning may be performed using different processing. For example, in an image forming apparatus not equipped with an fΘ lens, processing that makes the density uniform by changing the thinning amount of the pixels in a longitudinal direction can be applied through image processing. The present embodiment can also be applied in such a case.

According to the present disclosure, it is possible to prevent a drop in the accuracy of predicting the consumption amount of the developer (toner) when performing dithering on an input image.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-215048, filed Dec. 20, 2023, which is hereby incorporated by reference herein in its entirety.

What is claimed is:

1. An image forming apparatus comprising:
a photosensitive member;
a processing unit configured to generate an image signal by performing dithering as halftone processing on an input image;
an exposure unit configured to form an electrostatic latent image on the photosensitive member by exposing the photosensitive member on the basis of the image signal;
a developing unit configured to form a developer image on the photosensitive member by developing the electrostatic latent image using a developer; and
an obtainment unit configured to obtain a consumption amount of the developer for forming the developer image, on the basis of the image signal,
wherein the obtainment unit is configured to obtain the consumption amount using (i) a count value obtained by individually counting OFF pixel groups included in an image corresponding to the image signal, each OFF pixel group being constituted by consecutive OFF pixels and having a different consecutive number of consecutive OFF pixels, and (ii) a size of a dither matrix used in the dithering.

2. The image forming apparatus according to claim 1,
wherein the obtainment unit is configured to:
obtain a difference between the size of the dither matrix and the count value for the OFF pixel group corresponding to each consecutive number, as a count value for an ON pixel group having a corresponding consecutive number of consecutive ON pixels in a processing region of the image on which the dithering is to be performed; and
obtain the consumption amount on the basis of the count value for the ON pixel group corresponding to each consecutive number.

3. The image forming apparatus according to claim 2,
wherein the obtainment unit is configured to obtain the count value for an ON pixel group having a consecutive number smaller than the size of the dither matrix in the processing region of the image on which the dithering is to be performed.

4. The image forming apparatus according to claim 3,
wherein for ON pixel groups, the obtainment unit is configured to obtain the consumption amount corresponding to an individual consecutive number by applying a correction coefficient corresponding to the individual consecutive number to a total number of ON pixels obtained on the basis of the count value corresponding to the individual consecutive number.

5. The image forming apparatus according to claim 4,
wherein the obtainment unit is configured to obtain a sum of consumption amounts corresponding to the individual consecutive numbers for the ON pixel groups, as the consumption amount of the developer for forming the developer image.

6. The image forming apparatus according to claim 4,
wherein as the correction coefficient, a small correction coefficient is set for an ON pixel group having a small consecutive number, and a large correction coefficient is set for an ON pixel group having a large consecutive number.

7. The image forming apparatus according to claim 1,
wherein the obtainment unit is configured to further obtain a pixel count value obtained by counting ON pixels included in an image corresponding to the image signal, and obtain a normalized consumption amount on the basis of the consumption amount and the pixel count value.

8. The image forming apparatus according to claim 1,
wherein the obtainment unit is configured to obtain the consumption amount using (i) a count value obtained by individually counting OFF pixel groups included in an image corresponding to the image signal and having different consecutive numbers of consecutive OFF pixels, (ii) a count value obtained by individually counting ON pixel groups included in the image and having different consecutive numbers of consecutive ON pixels, and (iii) the size of the dither matrix used in the dithering.

9. The image forming apparatus according to claim 1,
wherein the processing unit is configured to generate an image signal in which each of pixels developed by the developing unit is partially thinned.

10. A control method for an image forming apparatus, comprising:
generating an image signal by performing dithering as halftone processing on an input image;
forming an electrostatic latent image on a photosensitive member by exposing the photosensitive member on the basis of the image signal;
forming a developer image on the photosensitive member by developing the electrostatic latent image using a developer; and
obtaining a consumption amount of the developer for forming the developer image, on the basis of the image signal,
wherein in the obtaining, the consumption amount is obtained using (i) a count value obtained by individually counting OFF pixel groups included in an image corresponding to the image signal, each OFF pixel group being constituted by consecutive OFF pixels and having a different consecutive number of consecutive OFF pixels, and (ii) a size of a dither matrix used in the dithering.

11. A non-transitory computer readable storage medium storing a program to execute a control method for an image forming apparatus, comprising:
generating an image signal by performing dithering as halftone processing on an input image;
forming an electrostatic latent image on a photosensitive member by exposing the photosensitive member on the basis of the image signal;
forming a developer image on the photosensitive member by developing the electrostatic latent image using a developer; and
obtaining a consumption amount of the developer for forming the developer image, on the basis of the image signal,
wherein in the obtaining, the consumption amount is obtained using (i) a count value obtained by individually counting OFF pixel groups included in an image corresponding to the image signal, each OFF pixel group being constituted by consecutive OFF pixels and having a different consecutive number of consecutive OFF pixels, and (ii) a size of a dither matrix used in the dithering.
